(19) United States
(12) Patent Application Publication
(10) Pub. No.: US 2011/0010351 A1
(43) Pub. Date: Jan. 13, 2011

(54) VERIFYING LOCALIZED PRODUCT VERSIONS

(75) Inventors: SVEN OLIVER SZIMMETAT, REDMOND, WA (US); RONEN BOAZI, BELLEVUE, WA (US); CHUNYAN (CATHY) ZHAO, REDMOND, WA (US); TIMOTHY CHRISTOPHER FRANKLIN, KIRKLAND, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, REDMOND, WA (US)

(21) Appl. No.: 12/500,058

(22) Filed: Jul. 9, 2009

(51) Int. Cl. G06F 17/30

(52) U.S. Cl. 707/695; 707/E17.014

(57) ABSTRACT

Systems, methods, and computer storage media having computer-executable instructions embodied thereon that verify localized product versions are provided. Resources are extracted from a localized file of a product version associated with a target language type. The resources are compared with target content of the target language type. In one embodiment, the target content is stored in a localization database. Upon the comparison of the resources with the target content, it is recognized whether the resources match the target content.

### BACKGROUND

Oftentimes, software products are localized (i.e., adapted, for example, via text translation or component addition) in accordance with various languages or dialects. By localizing a software product, users speaking a particular language can effectively utilize the software product. In some cases, a software product might not be successfully localized in conformance with a language. By way of example only, a portion of the product content might be omitted, redundant, incorrectly translated (e.g., misspelled or in another language), or the like. Accordingly, verifying localization of a software product assures that the software product is properly translated in accordance with a desired language. Manually verifying localization of software products can be time-consuming, incomplete, and inaccurate. For example, an individual analyzing a localized software program might not be entirely familiar with the language intended to be incorporated into the localized software product.

### SUMMARY

Embodiments of the present invention relate to systems, methods, and computer-readable media for, among other things, verifying localized product versions. Utilizing the systems and methods described herein, localization of a product version that has been initially translated in accordance with a specific language is verified. In some embodiments, resources, such as strings, text, images, and audio, are extracted from a file (e.g., binary file) of a product version. Such resources are compared with target content that indicates content in a particular language desired to be included in the product version. Based on the comparison of the resources with the target content, it can be verified whether the product version was correctly localized. As such, a user can more readily verify that the contents of a product version are in the correct form.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary computing system architecture suitable for use in implementing embodiments of the present invention;

FIG. 3 is a block diagram of an exemplary computer system for use in implementing embodiments of the present invention;

FIG. 4 is a flow diagram showing a first method for verifying a localized product version, in accordance with an embodiment of the present invention; and

FIG. 5 is a flow diagram showing a second method for verifying a localized product version, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention relate to systems, methods, and computer storage media having computer-executable instructions embodied thereon that verify localized product versions. A localized product version refers to a version of a product that has been translated or adapted to a particular language (e.g., writing system, language, dialect, region, etc.). Such a localized product version can enable a user to utilize the software product.

Accordingly, in one aspect, the present invention is directed to one or more computer storage media having computer-executable instructions embodied thereon for performing a method that verifies localized product versions. The method includes extracting resources from a localized file of a product version. The localized file is initially translated in accordance with a target language type. The resources are compared with target content in association with the target language type. Based on the comparison, it is determined that the resources match the target content. Verification of the localized file is output.

In another aspect, the present invention is directed to a computerized method that, when executed by a computing device, verifies localization of product versions. The method includes extracting localized files from a product version in association with a target language type. It is determined that a language property of each localized file matches the target language type. Resources are extracted from each of the localized files of the product version. The resources are compared with target content that corresponds with the target language type. The comparison is used to determine that each of the resources matches the target content for the target language type. It is presented that the product version was properly localized.

In yet another aspect, the present invention is directed to one or more computer storage media having computer-executable instructions embodied thereon that provides a method for verifying localized product versions. The method includes receiving an indication to initiate localization verification of a product version initially translated in accordance with a desired language. Binary files are extracted from the product version. A language property is identified for each binary file. It is recognized that the language property for each of the binary files corresponds with the desired language. Resources are extracted from the binary files of the product version. A localization database is used to compare the resources with target content. The target content is contained within the localization database and includes content in the desired language that is intended to be included in the product version associated with the desired language. It is determined if the resources match the target content. If each of the resources match the target content, an indication that the product version is properly translated in accordance with the desired language is provided. If any of the resources do not match the target content, an indication that the product version is not properly translated in accordance with the desired language is provided.

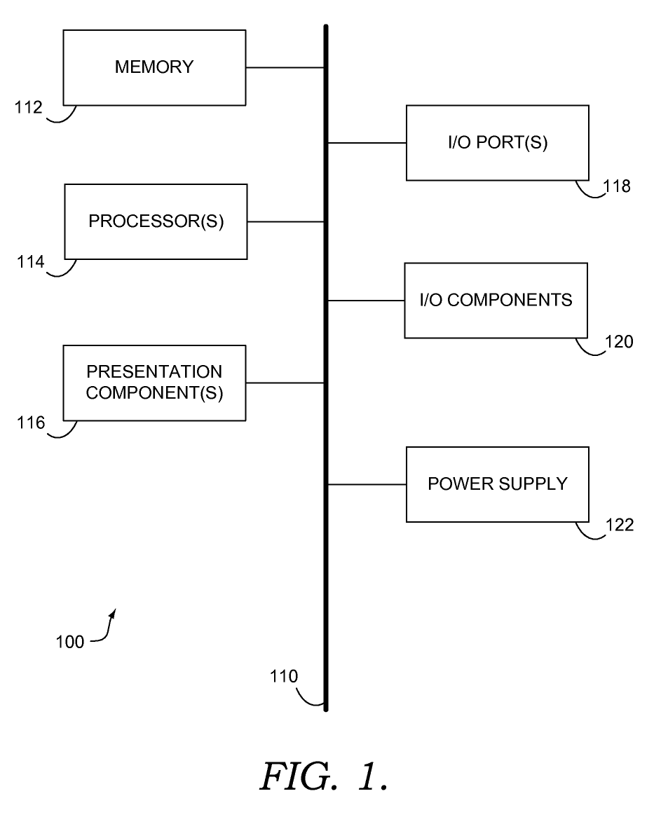

Having briefly described an overview of the present invention, an exemplary operating environment in which various aspects of the present invention may be implemented is described below in order to provide a general context for various aspects of the present invention. Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Additionally, many processors have memory. The inventors hereof recognizes that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

As previously set forth, embodiments of the present invention relate to computing systems, methods, and computer readable media for verifying localized product versions. That is, a localized product version is analyzed to verify that the product version was properly localized in accordance with a specific local market. As used herein, a product version refers to a version or variation of a software product. A software product can be any software product. An exemplary software product includes, but is not limited to, Microsoft's Windows®. A version of a software product might be based on a stock keeping unit (“SKU”) (e.g., Basic, Professional, Enterprise, Business, Starter, etc.), an architecture (e.g., x86, AMD64, IA64, etc.), and/or a language (e.g., Japanese, Simplified Chinese, Traditional Chinese, English, Spanish, Hindi, etc.). By way of example only, a software product might be released in twenty languages for five different SKUs and three different architectures resulting in 300 product versions. In one embodiment, a product version is at least intended to conform with a specific language.

Localization of a product version refers to the process of translating a product into a different language(s) (i.e., a localized product version). A localized product version, as used herein, refers to a software product translated or adapted to a particular language to adapt the product to a specific local market that is common to individuals within the same community, geographical region, and/or culture. As such, product features, such as the user interface, settings, metadata, text, images, and/or the like, are modified, added, or deleted to correspond with the language and/or culture of the local market for the product (i.e., the market in which the product is to be distributed or utilized). By way of example only, the English version of Microsoft's Windows® is adapted or converted into a Japanese version of Windows® so that it can be utilized in Japan.

Such localized product versions might be analyzed to verify that the product version appropriately incorporates the language desired, intended, or expected to be utilized in association with the product version. By way of example only, assume a product version is developed to be distributed in China. In such a case, the localized product version includes a form of the Chinese language that corresponds with the local market. A localized product version enables individuals that communicate using Chinese to interact with and correspond with the software product. As a software product, or a portion thereof, might not be properly, accurately, or completely translated into a desired language, verifying the localized product version (i.e., localization verification) ensures product quality. As such, localization verification is used to verify that the product version correctly uses the desired language.

As used herein, language refers to an oral communication, dialect, or writing system that is common to individuals within the same community, geographical region, and/or culture. By way of example only, types of languages include Chinese (e.g., Simplified or Traditional), English, German, Hindi, Italian, Japanese, Spanish, forms thereof, and the like.

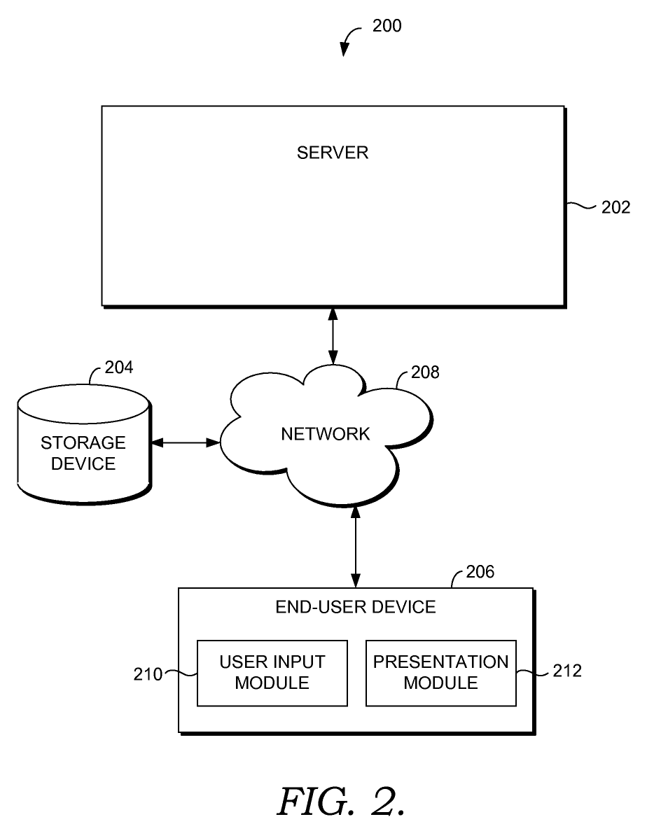

With reference to FIG. 2, a block diagram is illustrated that shows an exemplary computing system architecture 200 configured for use in implementing embodiments of the present invention. It will be understood and appreciated by those of ordinary skill in the art that the computing system architecture 200 shown in FIG. 2 is merely an example of one suitable computing system and is not intended to suggest any limitation as to the scope of use or functionality of the present invention. Neither should the computing system architecture 200 be interpreted as having any dependency or requirement related to any single module/component or combination of modules/components illustrated therein.

Computing system architecture 200 includes a server 202, a storage device 204, and an end-user device 206, all in communication with one another via a network 208. The network 208 may include, without limitation, one or more local area networks (LANs) and/or wide area networks (WANs). Such networking environments are commonplace in offices, enterprise-wide computer networks, intranets and the Internet. Accordingly, the network 208 is not further described herein.

The storage device 204 is configured to store information associated with software products. In various embodiments, such information may include, without limitation, text, images, audios, information associated therewith, and the like, in association with various languages. In embodiments, the storage device 204 is configured to be searchable for one or more of the items stored in association therewith. It will be understood and appreciated by those of ordinary skill in the art that the information stored in association with the storage device 204 may be configurable and may include any information relevant to one or more software products. The content and volume of such information are not intended to limit the scope of embodiments of the present invention in any way. Further, though illustrated as a single, independent component, the storage device 204 may, in fact, be a plurality of storage devices, for instance a database cluster, portions of which may reside on the server 202, the end-user device 206, another external computing device (not shown), and/or any combination thereof.

Each of the server 202 and the end-user device 206 shown in FIG. 2 may be any type of computing device, such as, for example, computing device 100 described above with reference to FIG. 1. By way of example only and not limitation, each of the server 202 and the end-user device 206 may be a personal computer, desktop computer, laptop computer, handheld device, mobile handset, consumer electronic device, or the like. It should be noted, however, that embodiments are not limited to implementation on such computing devices, but may be implemented on any of a variety of different types of computing devices within the scope of embodiments hereof.

The server 202 may include any type of application server, database server, or file server configurable to perform the methods described herein. In addition, the server 202 may be a dedicated or shared server. One example, without limitation, of a server that is configurable to operate as the server 202 is a structured query language (“SQL”) server executing server software such as SQL Server 2005, which was developed by the Microsoft® Corporation headquartered in Redmond, Wash.

Components of server 202 (not shown for clarity) may include, without limitation, a processing unit, internal system memory, and a suitable system bus for coupling various system components, including one or more databases for storing information (e.g., files and metadata associated therewith). Each server typically includes, or has access to, a variety of computer-readable media. By way of example, and not limitation, computer-readable media may include computer-storage media and communication media. In general, communication media enables each server to exchange data via a network, e.g., network 208. More specifically, communication media may embody computer-readable instructions, data structures, program modules, or other data in a modulated data signal, such as a carrier wave or other transport mechanism, and may include any information-delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media.

It will be understood by those of ordinary skill in the art that computing system architecture 200 is merely exemplary. While the server 202 is illustrated as a single unit, one skilled in the art will appreciate that the server 202 is scalable. For example, the server 202 may in actuality include a plurality of servers in communication with one another. Moreover, the storage device 204 may be included within the server 202 or end-user device 206 as a computer-storage medium. The single unit depictions are meant for clarity, not to limit the scope of embodiments in any form.

As shown in FIG. 2, the end-user device 206 includes a user input module 210 and a presentation module 212. In some embodiments, one or both of the modules 210 and 212 may be implemented as stand-alone applications. In other embodiments, one or both of the modules 210 and 212 may be integrated directly into the operating system of the end-user device 206. It will be understood by those of ordinary skill in the art that the modules 210 and 212 illustrated in FIG. 2 are exemplary in nature and in number and should not be construed as limiting. Any number of modules may be employed to achieve the desired functionality within the scope of embodiments hereof.

The user input module 210 is configured for receiving input. Typically, input is input via a user interface (not shown) associated with the end-user device 206, or the like. Upon receiving input, the presentation module 212 of the end-user device 206 is configured for presenting results of localization verification. Embodiments are not intended to be limited to visual display but rather may also include audio presentation, combined audio/video presentation, and the like.

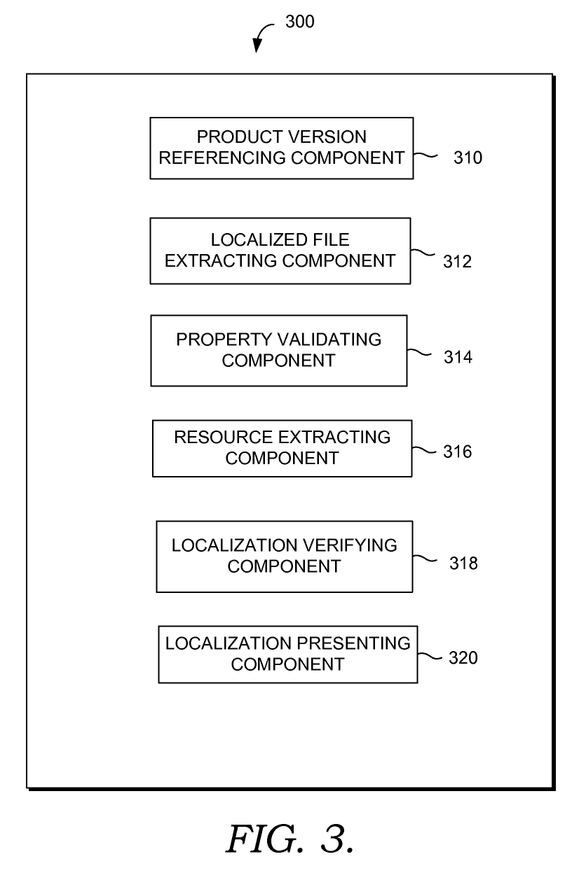

FIG. 3 illustrates an exemplary computing system 300 for verifying localized product versions. Stated differently, computing system 300 verifies localization of product versions. As shown in FIG. 3, an exemplary computing system 300 includes a product version referencing component 310, a localized file extracting component 312, a property validating component 314, a resource extracting component 316, a localization verifying component 318, and a localization presenting component 320. In some embodiments, one or more of the illustrated components may be implemented as stand-alone applications. In other embodiments, one or more of the illustrated components may be integrated directly into the operating system of the server 202, a cluster of servers (not shown) and/or the end-user device 206. It will be understood by those of ordinary skill in the art that the components illustrated in FIG. 3 are exemplary in nature and in number and should not be construed as limiting. Any number of components may be employed to achieve the desired functionality within the scope of embodiments hereof. Further, components may be located on any number of servers or computing devices. By way of example only, localization verifying component 318 may reside on a cluster of servers.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The product version referencing component 310 is configured to reference a product version. That is, a product version might be obtained, accessed, received, retrieved, installed, uploaded, downloaded, or the like. As previously discussed, a product version refers to any version of a software product. A product version might be based on any combination of, for example, a SKU, an architecture, and/or a language.

A product version might be referenced based on a user indication to perform a localization verification (i.e., verify that a product version was properly localized). In such a case, the user might utilize, for example, the user input module 210 of FIG. 2 to provide an indication to verify a localized product version. Alternatively, an indication to perform localization verification might be automatically invoked. Automatically invoking a verification might occur, for example, upon completing, updating, or installing a product version. In embodiments, the most recent developed product version is referenced to assure that the most recent or updated product version is correctly adapted to the desired language. In such an embodiment, the product version referencing component 310 might be configured to identify the most recent developed product version.

The localized file extracting component 312 extracts or references one or more localized files from a product version. As used herein, a localized file refers to a file, or a portion thereof, that has been localized in accordance with a local market, community, geographical region, and/or culture. In this regard, at least a portion of a localized file has been initially translated, transformed, or adapted to correspond with a desired language (e.g., Spanish). As such, an effort has been made to translate a software product into a particular language or otherwise adapt a software product in accordance with a particular language (e.g., add, delete, or modify components or elements). In some cases, a localization attempt might result in a localized file that conforms with a specific language while, in other cases, a localization might result in a localized file that improperly conforms with a specific language (e.g., a portion misspelled, incomplete, inaccurate, redundant, etc.). A localized file may be a binary file, text file, word document, or the like.

A product version might include one or more ISO image files, archive files, cabinet files, installer packages, download packages, or a combination thereof. In one embodiment, a product version contains an executable file(s), an image file(s), or a combination thereof. By way of example only, to install Microsoft's Windows Vista® service file, an executable file that contains all of the modified files is downloaded.

Accordingly, the localized file extracting component 312 can extract localized files from one or more ISO image files, archive files, cabinet files, installer packages, download packages, or a combination thereof, of a product version. In embodiments, for each language, a localized product version includes an executable file or image file that contains binary files, text files, and/or word documents that are intended to correspond with that language. For example, a product version having a “Basic” SKU and an “x86” architecture can include one executable or image file in association with the Spanish language. In such a case, the executable or image file might contain thousands of binaries.

The property validating component 314 is configured to validate language properties. A language property, as used herein, refers to a property that indicates the language of a corresponding file (e.g., a localized file). In this regard, a language property can define the main or generally used language of a file. In one embodiment, the property validating component 314 validates a language property for each of the extracted localized files. In such a case, each extracted localized file includes a language property (e.g., metadata) that specifies the language generally utilized within the file. In an alternative embodiment, the property validating component 314 validates language properties of a portion of the extracted or referenced localized files.

In embodiments, the property validating component 314 validates that the language property of a localized file corresponds with the target language type of the localized file. A target language type, as used herein, is a type of language (e.g., via text, audio, video, image, etc.) that is expected or intended to be utilized within a product version, or portion thereof (e.g., a localized file). By way of example only, assume that a target language type of a localized file is “German.” That is, “German” is the language type intended to be utilized in association with the localized file. In such a case, the property validating component 314 can validate the language property of the localized file if the language property in association with the localized file indicates “German.” A language property of a localized file might be presented within a file header (e.g., in association with a word document), XML, directory structure location, or any metadata of the localized file.

A target language type of a localized file or product version can be identified or determined using any enabling method. In one embodiment, a target language type is identified based on a location that indicates a target language type of the localized file or product version (e.g., a file path, folder path). By way of example only, a localized product version, or file thereof, might be organized using a directory structure. In such a case, assume that a folder exists for each target language (e.g., a Spanish folder, a German folder, etc.). That is, each file within the folder is expected to utilize the target language (e.g., Spanish).

To validate the language property of a particular file located within a folder (e.g., a Spanish folder), the property validating component 314 might verify that the language property (e.g., Spanish) in association with the particular file corresponds with the location of the localized file (e.g., Spanish folder). In this regard, the property validating component 314 compares the language property of the file with the location of the localized file that indicates the target language type. For instance, the language property of a localized file located within a folder in association with the Spanish language can be validated if the localized file contains a language property indicating the localized file utilizes the Spanish language (i.e., the language property of the file matches the target language type of the file based on the file location). As can be appreciated, any method can be used to validate a language property.

The resource extracting component 316 extracts resources from localized files. In this regard, resources in association with a localized file are referenced. As such, a localized file might be parsed for resources. A resource, as used herein, refers to content, text, a string, an image, an audio, or any other data within a localized file. In embodiments, the resource extracting component 316 extracts resources from binary files, word documents, text files, and/or the like.

In one embodiment, the resource extracting component 316 extracts resources based on the type of localized file, e.g., file format. By way of example only, assume a product version contains 100 localized files, some of which are documents, executables, html pages, etc. In such a case, resources can be extracted based on the file type. For instance, in cases that NET assembly is utilized in association with a localized file, resources can be extracted using NET Reflection. Alternatively, resources can be extracted using PE (portable executable) file format.

The localization verifying component 318 verifies localization of product versions and/or localized files. That is, the localization verifying component 318 verifies that a product version or file (e.g., binary file, text file, etc.) is properly or correctly localized in accordance with a target language type. Accordingly, the localization verifying component 318 verifies that language used in a localized product corresponds with the target language type. By way of example only, assume that a target language type of a product version and/or localized file is “Spanish.” In such a case, the localization verifying component 318 can verify that a file is properly localized if the Spanish language is correctly utilized within the file. As can be appreciated, a target language type can be identified or recognized using any method, such as, for example, based on location of the product version and/or localized file, user input, metadata, file content, etc. The localization verifying component 318 can verify localization of localized product versions or files automatically (i.e., without user intervention).

To verify localization, in embodiments, the localization verifying component 318 utilizes the resources, or a portion thereof, extracted from a localized file. In one embodiment, language detection might be performed on extracted resources to provide an indication of the actual language type used within the localized file. Such an actual language type can be compared with the target language type to verify localization. In an alternative embodiment, the extracted resources are compared with target content for the localized file. Target content refers to content (e.g., text, strings, audio, images, etc.) that is expected or intended to be utilized within a product version, or portion thereof (e.g., a localized file), in association with a target language type. As such, target content corresponds with the target language type for a particular product version or localized file. For example, assume that a target language type for a localized file is “German.” In such a case, target content for the localized file includes language (e.g., text, strings, audio, images, etc.) that corresponds with “German.”

In embodiments, target content might be contained in a database (i.e., localization database) or other storage system, such as storage device 204 of FIG. 2. As such, the localization verifying component 318 can compare resources extracted from a localized file with target content in a localization database to verify that a product version or file has been properly localized (i.e., converted into the desired language). In this regard, the localization verifying component 318 can identify or determine whether a resource of a localized file matches the corresponding target content within the localization database.

A localization database might contain target content for multiple language types. In some cases, the database might be associated with a particular software product or a variety of products. For instance, assume that a localization database exists or is generated to correspond with a specific software product. As such, the database might contain target content for each language type associated with the product. If the software product is to be distributed in English, Spanish, German, and French, a corresponding localization database may contain target content in each of those languages. A localization database can contain target content in any form, such as, for example, text, strings, entire documents (e.g., licensing agreements), images, audios, or the like.

A localization database might be organized by language type, product version, a combination thereof, or the like. A query can be performed to determine if a resource of a localized file is contained within the target language portion of the localization database for the product version. Accordingly, the localization verifying component 318 can identify or determine whether a resource matches target content within the localization database (e.g., within the target language portion of the localization database). By way of example only, assume that a target language type for a product version is Spanish and that a string “uno” is extracted from a localized file of the product version. In such a case, based on the extracted resource, the localization verifying component 318 can utilize the localization database to verify that the extracted resource “uno” corresponds with the target language type “Spanish.” That is, the localization verifying component 318 can access the “Spanish” portion of the localization database and identify that the resource matches target content within the “Spanish” portion. As such, in embodiments, a binary equivalent can be performed to verify that the extracted resource matches or is equivalent to target content within a localization database, or portion thereof (e.g., a portion corresponding with the target language type of the product version and/or localized file). In embodiments, the most recent localization database or last known good state of the database is utilized by the localization verifying component 318. Using the most recent localization database or last known good state enhances quality of the verification. Language detection can be used to analyze a localization database and verify accuracy of the database.

In some embodiments, a portion of resources are verified. For example, in some cases, not all resources are localized. Rather, a file might be partially translated, for instance, to ship to smaller markets. In such cases, the localization database might recognize the resources intended to be localized and/or the resources intended not be localized in accordance with a target language.

In addition to verifying localization via a language property and/or a localization database, in some embodiments, localization can be alternatively or additionally verified using a language detection interface. A language detection interface (e.g., an API), provides the language of a resource (e.g., text, a string, an image, an audio, etc.). By way of example, and not limitation, when parsing a string, a language detection interface can recognize and/or indicate the language type of the string.

A localization database can also be used to identify whether a product version or localized file is missing content or contains redundant content. For example, language from one product version or localized file can be compared to target content within a localization database. Upon such a comparison, records or target content in the database that has not been checked might indicate such data is missing from the product version or localized file. On the other hand, records or target content in the database that have been accessed multiple instances might indicate that such data is redundant. In some embodiments, multiple language types might be compared against a localization database to identify content that should be included within a product version or localized file.

A localization presenting component 320 is configured to present results of the localization verification. As such, the localization presenting component 320 might present whether the product version and/or localized file was appropriately, correctly, or successfully localized. That is, the localization presenting component 320 might output whether a language property corresponds with a target language type, whether a resource matches target content within a localization database, or portion thereof, whether a resource is in the target language type, whether content is missing or duplicative. Localization presenting component 320 might display and/or provide audio output to notify a user whether a product version and/or localized file contains content (e.g., text, strings, audios, images, etc.) in accordance with the target language type.

The localization presenting component 320 might present the resources that are incorrect, missing, or redundant. In some embodiments, the localization presenting component 320 also indicates how to achieve proper localization.

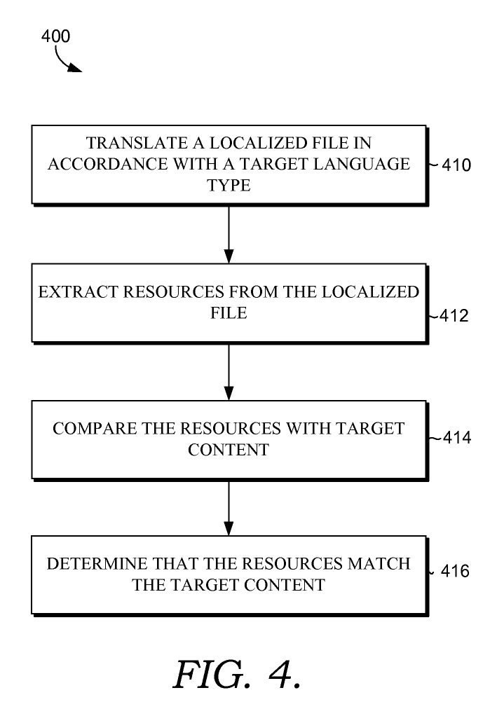

Turning now to FIG. 4, a flow diagram is illustrated which shows a first method 500 for verifying localized product versions, in accordance with an embodiment of the present invention. Initially, at block 410, a localized file is initially translated in accordance with a target language type. Subsequently, at block 412, resources are extracted from the localized file of a product version. The resources are compared to target content in association with the target language type. This is indicated at block 414. In some embodiments, the target content is stored in a localization database. Based on the comparison, at block 416, it is determined that the resources match the target content.

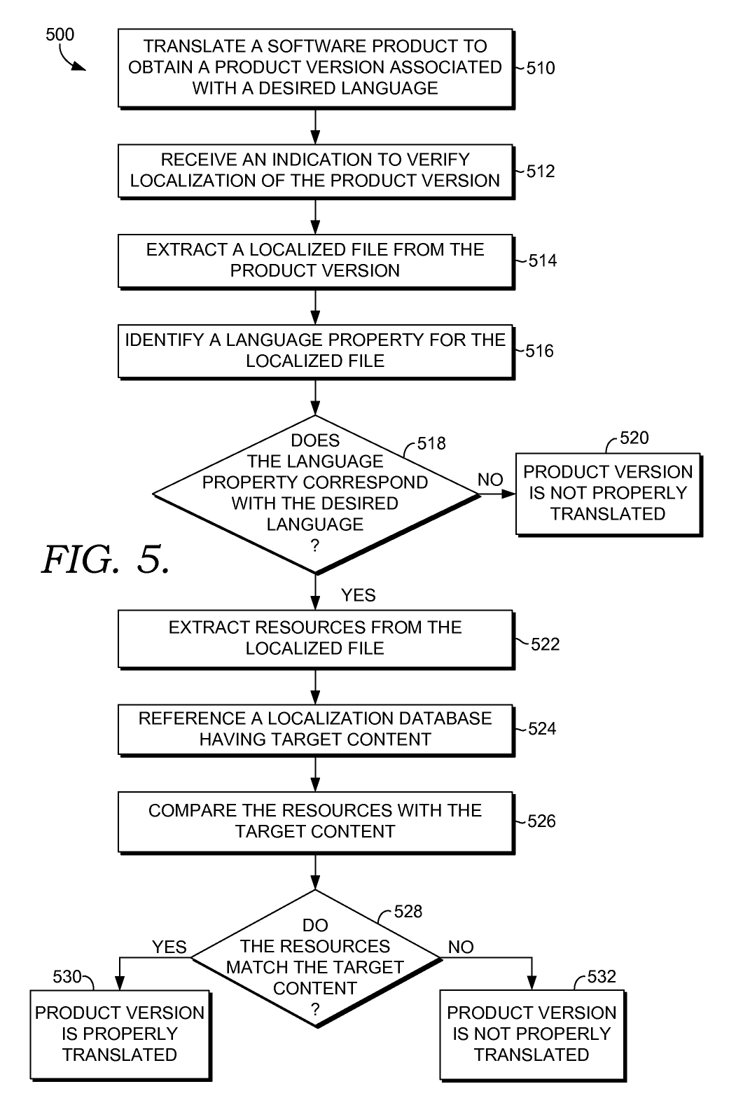

With reference to FIG. 5, a flow diagram is illustrated which shows a second method 500 for verifying localized product versions, in accordance with an embodiment of the present invention. Initially, as indicated at block 510, a software product is translated in accordance with a desired language resulting in a product version. Subsequently, at block 512, an indication to initiate localization verification of the product version is received. In one embodiment, localization verification is initiated via a user indication. A localized file, such as a binary files, text files, or word files, is extracted from the product version, as indicated at block 514. At block 516, a language property is identified for each localized file. It is determined at block 518 whether the language property for the localized file corresponds with the desired language. If it is determined at block 518 that the language property does not correspond with the desired language, at block 520 an indication that the product version is not properly translated in accordance with the desired language is provided.

If, however, it is determined at block 518 that the language property corresponds with the desired language, resources are extracted from the localized file at block 522. Resources might include, by way of example and not limitation, text, strings, audios, images, and the like. At block 524, a localization database having target content is referenced. The resources are compared with the target content within the localization database. This is indicated at block 526. At block 528, it is determined whether the resources match the target content. If it is determined that the resources match the target content, at block 530 an indication that the product version is properly translated in accordance with the desired language is provided. On the other hand, if it is determined that any of the resources do not match the target content, an indication that the product version is not properly translated in accordance with the desired language is provided. This is indicated at block 532.

It will be understood by those of ordinary skill in the art that the order of steps shown in the method 400 of FIG. 4 and the method 500 of FIG. 5 are not meant to limit the scope of the present invention in any way and, in fact, the steps may occur in a variety of different sequences within embodiments hereof. Any and all such variations, and any combination thereof, are contemplated to be within the scope of embodiments of the present invention.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media having computer-executable instructions embodied thereon, that when executed, cause a computing device to perform a method that verifies localized product versions, the method comprising:
extracting one or more resources from a localized file of a product version, the localized file initially translated in accordance with a target language type;
comparing, without user intervention, the one or more resources with target content in association with the target language type; and
based on the comparison, determining that the one or more resources match the target content.

2. The one or more computer storage media of claim 1 further comprising referencing the localized file in association with the product version.

3. The one or more computer storage media of claim 1, wherein the localized file comprises an executable file, a text file, or a word document.

4. The one or more computer storage media of claim 1, wherein the target content is contained within a localization database.

5. The one or more computer storage media of claim 1, wherein the one or more resources are extracted based on a type of the localized file.

6. The one or more computer storage media of claim 1 further comprising displaying verification of the localized file.

7. The one or more computer storage media of claim 1 further comprising identifying the target language type.

8. The one or more computer storage media of claim 7, wherein the target language type is identified based on user input, directory structure, or metadata.

9. The one or more computer storage media of claim 1 further comprising extracting the localized file from the product version.

10. The one or more computer storage media of claim 9 further comprising comparing a language property of the localized file to the target language type.

11. A computer-implemented method that, when executed by a computing device, verifies localization of product versions, the method comprising:
extracting a plurality of localized files from a product version in association with a target language type;
determining that a language property of each of the plurality of localized file matches the target language type;
extracting resources from each of the plurality of localized files of the product version;
comparing, without user intervention, the resources with target content that corresponds with the target language type;
utilizing the comparison to determine that each of the resources matches the target content for the target language type; and
presenting that the product version was properly localized.

12. The computerized method of claim 11 further comprising determining a file type for each of the plurality of localized files.

13. The computerized method of claim 12 further comprising extracting the resources from each of the plurality of localized files based on the file type.

14. The computerized method of claim 13, wherein each of the plurality of localized files comprises a binary file, a text file, a word document, or a combination thereof.

15. The computerized method of claim 11 further comprising initiating localization verification.

16. The computerized method of claim 11, wherein localization verification is initialized automatically or based on a user indication.

17. The computerized method of claim 11, wherein the language property of each of the plurality of localized files is located within the file header, XML, or other metadata of the corresponding localized file.

18. One or more computer storage media having computer-executable instructions embodied thereon, that when executed, cause a computing device to perform a method that verifies localized product versions, the method comprising:
translating a software product in accordance with a desired language to obtain a product version;
receiving an indication to initiate localization verification of the product version initially translated in accordance with a desired language;
extracting at least one binary file of the product version;
identifying a language property for each of the at least one binary file;
recognizing that the language property for each of the at least one binary file corresponds with the desired language;
extracting one or more resources from the at least one binary file of the product version;
using a localization database to compare the one or more resources with target content, the target content being contained within the localization database and comprising content in the desired language that is intended to be included in the product version associated with the desired language; and
determining whether the one or more resources match the target content,
if each of the one or more resources match the target content, providing an indication that the product version is properly translated in accordance with the desired language, and
if any of the one or more resources do not match the target content, providing an indication that the product version is not properly translated in accordance with the desired language.

19. The one or more computer storage media of claim 18, wherein if any of the one or more resources do not match the target content, specifying the one or more resources that do not match the target content.

20. The one or more computer storage media of claim 18, wherein the one or more resources comprise a string, text, an image, an audio, or a combination thereof.
